(19) United States
(12) Patent Application Publication
(10) Pub. No.: US 2017/0356882 A1
(43) Pub. Date: Dec. 14, 2017

(54) DEVICE AND METHOD FOR BUBBLE SIZE CLASSIFICATION IN LIQUIDS

(71) Applicant: UNIVERSIDAD DE CHILE, Santiago de Chile (CL)

(72) Inventors: Néstor BECERRA YOMA, Santiago de Chile (CL); Muhammad Salman KHAN, Santiago de Chile (CL); Walid Gad Barakat HUSSEIN, Santiago de Chile (CL); Felipe Sebastián ESPIC CALDERÓN, Santiago de Chile (CL); Juan Antonio ZAMORANO NAVARRO, Santiago de Chile (CL)

(21) Appl. No.: 15/541,338

(22) PCT Filed: Dec. 29, 2015
(86) PCT No.: PCT/CL2015/050061

§ 371 Date: Jun. 30, 2017

(30) Foreign Application Priority Data
Dec. 30, 2014 (CL) 3603-2014

(51) Int. Cl. G01N 29/036; G01N 29/42; G01N 29/44

(52) U.S. Cl. CPC G01N 29/036; G01N 29/4481; G01N 29/42

(57) ABSTRACT

The present invention is related to a device and a method using said device for the measurement and classification of bubble sizes in a liquid medium. This invention comprises two electric emitter and receiver transducers located at an angle lower than 180 degrees one with respect to the other, and ultrasonic signal emitter and receiver circuits operatively connected to the electric emitter and receiver transducer respectively. The classification of the bubble sizes is based on two-dimensional time domain patterns that represent the trace of the bubbles when they cross a generated ultrasonic field. This invention is of great utility to track processes involving the generation of bubbles in liquid media such as the froth flotation in mining.

### TECHNICAL FIELD OF THE INVENTION

The present invention is related to the technical field of the methods and devices for measuring, specifically to methods for classifying and measuring sizes, particularly with a device and a method that use said device for the measurement and classification of bubbles sizes in a liquid medium.

### BACKGROUND OF THE INVENTION

Fluids containing a high content of bubbles are broadly used in a variety of industries such as mining, foods, medicine and other industrial processes. The fluxes of bubbles through liquids are key proceedings in processes such as fermentation in bioreactors, biological treatments of sewage water, or for separation of minerals. It is broadly known that the size, density and movement of the bubbles affect the efficiency of these processes and, therefore, the measurement and control of the bubbles flux is critical.

Particularly, the process of froth flotation is a system using the flux of bubbles as a physical method for separating hydrophobic particles from the hydrophilic ones. For example, in mining, this process allows the mineral particles of interest found in flotation cells to adhere to the bubbles and rise to the surface, from where they are collected. Currently, this process is being used in various applications, such as copper minerals separation, which are of a high importance and worthiness for Chile; separation of sulfur minerals from silica gangue (and other sulfur minerals); separation of potassium chloride (sylvite) from sodium chloride (halite); separation of carbon from minerals that compose ashes; elimination of the silicate minerals from iron minerals; separation of phosphate minerals from silicates; and even non mineral applications such as the elimination of ink from recycled press paper, among others (Kawatra S. K. Froth Flotation-Fundamental Principles. Michigan Technological University. Department of Chemical Engineering. College of Engineering. 2011).

For understanding the bubbles fluxes, different strategies for determining the shape, diameter or volume of each bubble found in the fluid have been developed, however, a standard measurement does not exist. Some methods for characterizing and detecting bubbles are based on passive acoustic techniques, capillary suction tests, high speed photography, endoscopic optical tests and optical waveguides sensors (Vazquez A., Sanchez R. M., Salinas-Rodriguez E., Soria A., Manasseh R. A look at three measurement techniques for bubble size determination. Measurement Science & Technology. 2004(15): 290-296).

The patent document GB2336905 describes a method for monitoring bubbles in a moving liquid medium that uses a light beam emitter and a receiver that detects variations or interferences in said beam, whose bubble size and density are obtained directly from the analysis of the received signal. However, the optical methods are limited by the light condition and the purity of the liquid for the measurement, considerably reducing the range of applications in which these can be used and the accuracy of the measurements.

Regarding the acoustic methods, the patent document WO2014016110 describes a method for determining the bubble size distribution in a liquid, measuring acoustic signals in a range from 50 to 500 Hz. This method is based on determining the natural frequency of oscillation of a bubble depending on its size (diameter). The typical use of single frequencies has exhibited certain limitations, such as the masking of small bubbles in presence of larger ones (Leighton T. G. The acoustic bubble. Academic Press, London, UK. 1994: 129-152). By using two frequencies in a non-lineal mix of signals, the probability of false detection is reduced and it represents a relatively accurate method for the detection and measurement of gas bubbles. Nevertheless, this method has been typically used for the detection of a single bubble size, taking the second resonance harmonic as a global maximum, whereas other non-lineal sources could be inducing a signal. Although these signals reach their maximum around the resonance of the bubble, the same suffer effects from other sound sources, such as turbulences, transducer effects, etc., which can generate signals detecting the presence of a resonant bubble when the same is not present. (Ainslie M. A., Leighton T. G. Review of scattering and extintion cross-sections, damping factors, and resonance frequencies of a spherical gas bubble. The Journal of the Acoustical Society of America. 2011(130): 3184-3208).

In the state-of-the-art of the technique it has also seen that the studies consider simple bubble resonance models, ignoring the elastic effects related to the surface of the same, such as stiffness, multi-bubble effect, inertia and proximity to the boundaries. Additionally, the method of resonance is difficult to apply on-line, because the excitation frequency varies on a given range to find that one in which the bubble resonates with the higher intensity, that is, if the next bubble is not of the same size than the previous one, the resonance method loses sensitivity and accuracy.

Furthermore, the previous art shows some methods for the detection and measurement of bubble sizes using ultrasound. For example, the document US 2002/0134134 mentions the use of an envelope detector for the detection of bubbles in blood in a medical device. The blood with bubbles passes through a tube with a certain velocity, assuming that both the liquid and the bubbles have the same velocity. An emitter and a receiver are positioned transverse to the tube in line of sight, that is, one facing the other. The bubbles go through and cut the ultrasound beam, and the energy attenuation detected by the receiver gives an estimation of the diameter of the bubbles.

Another similar invention is described in the patent document US 2014/0360248 in which two ultrasonic emitters and two ultrasonic receivers positioned facing each other through a tube in which the liquid with bubbles flow are used. The ultrasonic signal generators can be adapted to emit pulses or signal sequences, which are disturbed when a bubble goes through the signal. These mentioned methods have limited applicability because they require both transducers to be positioned facing each other at a short distance, enough for the ultrasound signal not to be affected by interferences from the medium. Additionally, it is designed to detect one bubble at a time, preventing it to be used, for example, in froth flotation tanks in which the bubbles rise freely to the surface having irregular paths, different velocities and non-uniform radial distance to the center of the ultrasound beam by passing through a tube having a limited diameter with the transducer being positioned at a short distance.

In consequence, an alternative optimized method of measurement, classification and analysis of bubble size is required, capable of performing the analysis in line and simultaneously to a heterogeneous group of bubble sizes, with a high level of accuracy and low number of masking errors.

### SUMMARY OF THE INVENTION

An object of the present invention is to provide a device for the classification of bubble size in a liquid medium, said device comprising:

an electric ultrasonic signal emitter transducer;

an electric ultrasonic signal receiver transducer; located at an angle lower than 180 degrees with respect to the electric ultrasonic signal emitter transducer;

ultrasonic signal emitter and receiver circuits operatively connected to said electric ultrasonic signal emitter and receiver, respectively;

an analogue-to-digital converter connected to the ultrasonic signal receiver circuit;

a processor for digitalized signals connected to the analogue-to-digital converter.

The electric ultrasonic signal receiver transducer is preferably located at an angle of 90 degrees with respect to the electric ultrasonic signal emitter transducer.

The emitter circuit comprises an ultrasonic signal generator coupled to a power amplifier and this one to an impedance adapter. Said ultrasonic signal generator generates a time sustained signal of fundamental frequency f_{c} which is emitted by the electric emitter into the liquid. The signal emitted into the liquid is of sinusoidal kind, whose wavelength, corresponding to the frequency f_{c} has to be lower than the smallest of the diameters of the bubbles to be classified.

The ultrasonic signal receiver circuit comprises a band pass filter which exhibits a band pass having the same central frequency f_{c} that the signal generated by the emitter circuit. Next to the band pass filter is situated a signal amplified and, coupled to this one, an envelope detector. On its side, the envelope detector comprises a wave rectifier bridge, connected to a low pass filter, and a differential amplifier connected to this last one.

A second object of the invention is related to a method for the classification of bubble sizes comprising the steps of:

generating an ultrasonic field by means of an ultrasonic signal emitter circuit and emitting said ultrasonic field by means of an electric ultrasonic signal emitter transducer;

detecting bubbles that cross said ultrasonic field by means of an electric ultrasonic signal receiver transducer, said bubbles that reflect ultrasonic signals in correspondence to their rising velocity that depends on their size;

processing, with an ultrasonic signal receiver circuit, the ultrasonic signal reflected by the bubbles for generating two-dimensional time-domain patterns containing information of the size of the same;

processing the two-dimensional time-domain patterns by means of digital processing techniques of signals in the frequency domain for generating frequency-domain patterns containing information of the size of the bubbles;

classifying said frequency-domain patterns related to the size of the bubbles by means of a step of training of a classifier and a step of operating with the trained classifier.

The ultrasonic signal, generated by the ultrasonic signal emitter circuit is a time sustained signal having a fundamental frequency f_{c} that is emitted by the electric transducer into the liquid. The signal emitted into the liquid is of a sinusoidal kind, whose wavelength, corresponding to the frequency f_{c} has to be lower than the smallest diameter of the bubbles to be classified.

The aforementioned receiver circuit performs additional steps for the processing of the ultrasonic signal reflected by the bubbles, in order to generate time-domain two-dimensional patterns containing information of the size of the same. These additional steps are:

filtering the ultrasonic signals reflected by the bubbles in a band pass filter; amplifying the filtered reflected ultrasonic signals; and extracting the envelope of the signals reflected by the bubbles, by means of an envelope detector.

Additionally, the step of extracting the envelope of the signals reflected by the bubbles in order to generate the time-domain two-dimensional patterns containing information of the size of the same comprises the steps of:

rectifying the signal reflected by the bubbles by means of a rectifier bridge;

filtering the rectified ultrasonic signals reflected by the bubbles by means of a low-pass filter to obtain the time-domain two-dimensional patterns; and

amplifying the two-dimensional patterns by means of an amplifier connected to an analogue to digital converter.

After obtaining the time-domain two-dimensional patterns, the same are processed by digital processing techniques of signals in the frequency domain for the generation of frequency-domain patterns containing information of the size of the bubbles and comprising the additional steps of:

dividing the ultrasonic signals in frames having a constant duration and multiplying them by an appropriate window;

estimating simultaneously in each frame the fast Fourier transform and the linear prediction coefficients; and

extracting from the fast Fourier transform and the linear prediction coding the necessary parameters for the classification of the bubbles size.

These necessary parameters for the classification of the bubbles size resulting from the frequency domain processing by means of the fast Fourier transform and the linear prediction coding are selected from the group including spectral centroid, spectral energy, spectral entropy, spectral slope, spectral crest factor, spectral roll off and linear prediction coefficients, as well as any other parameter for the classification of the bubbles size.

For classifying the frequency-domain patterns related to the size of the bubbles it is performed a training step of a classifier, that is selected from the group including neural networks and the Bayesian classifier, and an operating step with the trained classifier. The training step of the classifier comprises estimating the coefficients of the classifier from the parameters obtained from the frequency-domain patterns necessary for the classification of the bubbles, using bubbles of known sizes. Then, for the step of operating with the trained classifier the parameters obtained from the frequency-domain patterns of bubbles of unknown sizes are used and they are classified according to their sizes with the trained classifier.

### BRIEF DESCRIPTION OF THE DRAWINGS

FIG. 1 shows a representative schematic of the invention, indicating the parts of the device and the functional connection between its parts.

FIG. 2 shows a representative schematic of the ultrasonic signal emitter circuit.

FIG. 3 shows a representative schematic of the receiver circuit of the signals reflected by the bubbles.

FIG. 4 shows a representative schematic of the configuration of the electric ultrasonic signal emitter and receiver transducers and the generated ultrasonic field.

FIG. 5 is an example of time-domain two-dimensional patterns of different bubble sizes.

FIG. 6 is a schematic or process flux showing the processing for obtaining the necessary parameters for the classification of the bubble size.

FIG. 7 shows an example of an embodiment of the invention in a froth flotation cell used in mining.

### DETAILED DESCRIPTION OF THE INVENTION

The present invention is related to a device and a method using said device for the measurement and size classification of air bubbles present in a liquid medium. The invention uses an approach of classification of two-dimensional (2-D) time-domain patterns representing the traces of bubbles when they cross a directive ultrasonic beam or an ultrasonic field generated by an emitter transducer coupled to an emitter circuit. The energy reflected by the bubbles crossing this field is captured by a receiver transducer coupled to a receiver circuit.

The processing of said 2-D time-domain patterns allows to obtain frequency-domain patterns, being the average spectral distribution representative of the corresponding bubble sizes. After the training of a classifier with parameters obtained from the frequency-domain patterns of bubbles of known sizes, the unknown sizes of the analyzed bubbles can be classified.

The flow of bubbles in liquids is an important part of a series of industrial processes, in which the size, and therefore the velocity of the bubbles introduced into the liquid are a crucial step for obtaining an adequate and efficient process. Consequently, the present invention provides a device and a method using said device for the measurement and classification of the size of the bubbles flowing inside a liquid in an industrial process. This invention provides a simultaneous and precise measurement of a plurality of bubbles raising through a liquid medium, estimating the parameters obtained from the frequency-domain patterns and classifying the bubbles size on-line, that finally allows to modify the entry of air flux into the liquid in order to optimize the industrial process.

For a further clarity of the invention, a series of representative figures exemplifying the device, its components and functional connections between its parts are shown. It is to be considered that the figures shown here are just a representation of the invention and are not to be considered as a limitation of it.

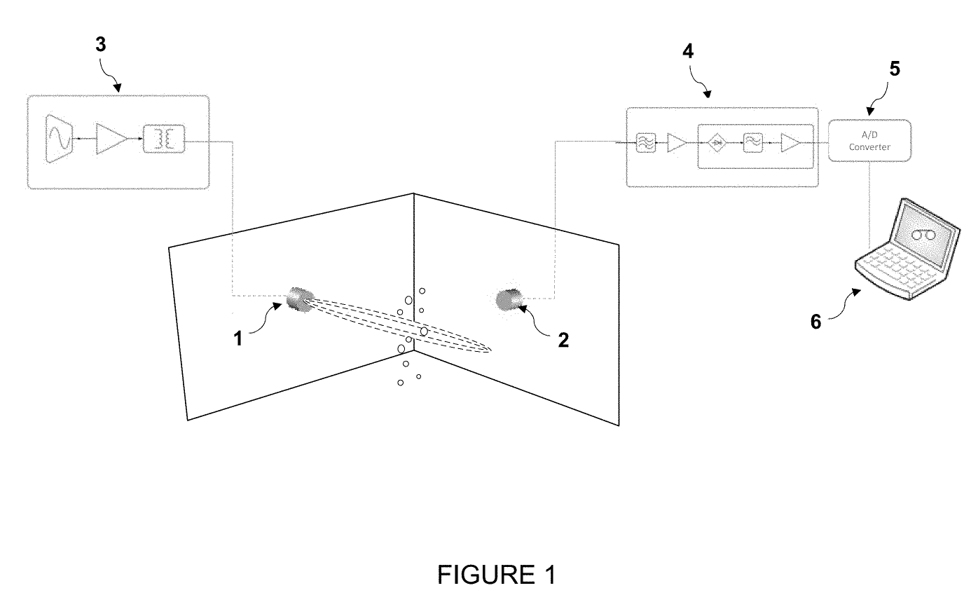

FIG. 1 shows a general schematic of the device and the functional connection between all its components. The device for the classification of bubbles size in a liquid medium comprises an electric ultrasonic signal emitter transducer 1 and an electric ultrasonic signal receiver transducer 2, located at an angle lower than 180 degrees with respect to the electric emitter transducer 1. In a preferred embodiment, the angle between the electric emitter transducer 1 and the electric receiver transducer 2 is 90 degrees, as shown in FIG. 1. The configuration between the transducers at an angle lower than 180 degrees allows a correct measurement of the signal reflected by the bubbles, being even allowable to locate them at an angle of 0 degrees, that is, one next to the other, without affecting greatly the principle of the methodology.

The electric emitter transducer 1 is operatively connected to an ultrasonic signal emitter circuit 3 that generates the ultrasonic signals that are then emitted by the electric emitter transducer 1. On its side, the electric receiver transducer 2 is operatively connected to an ultrasonic signal receiver circuit 4, that process the signals reflected by the bubbles. These processed signals are converted to digital signals by means of an analogue-to-digital converter 5. Said digital signals are processed by means of a digitalized signal processor 6.

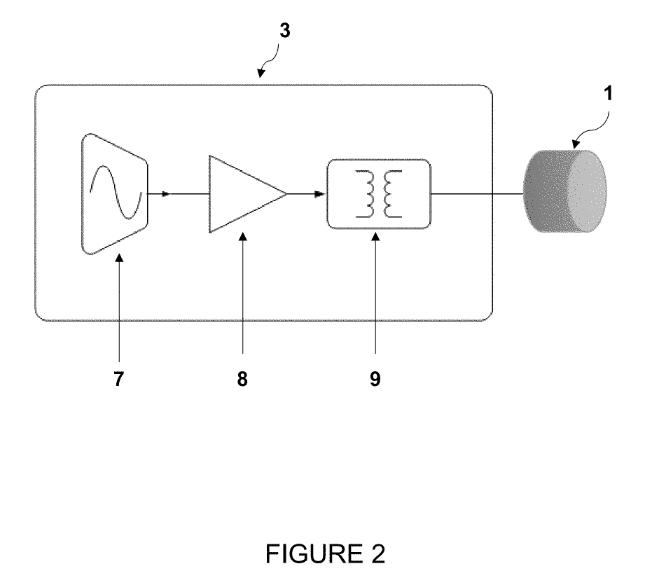

FIG. 2 shows the components that preferably compose the signal emitter circuit 3. It is composed of an ultrasonic signal generator 7 that produces a time sustained signal having a fundamental frequency f_{c} that is then emitted by the electric emitter transducer 1 into the liquid. Said periodic signal generated by the signal generator 7 may be sinusoidal, square or of any kind, nevertheless, the signal emitted into the liquid is sinusoidal and the wavelength in the liquid has to be lower than the smallest diameter of the bubbles to be classified in order to the bubble reflects the signal. For example, in a plurality of bubbles was determined that the smallest diameter was 2.5 mm. To measure and classify the sizes of said plurality of bubbles, it was used a sinusoidal signal having a frequency of 1 MHz, equivalent to a wavelength of approximately 1.5 mm, in order to include all the sizes of bubbles to consider. Operatively coupled to the ultrasonic signal generator 7 there is a signal amplifier 8 that allows to amplify the power of the signal to an adequate level, and this one on its side is coupled to an impedance adapter 9 to avoid power losses of the signal when the same passes to the electric emitter transducer 1 to be emitted.

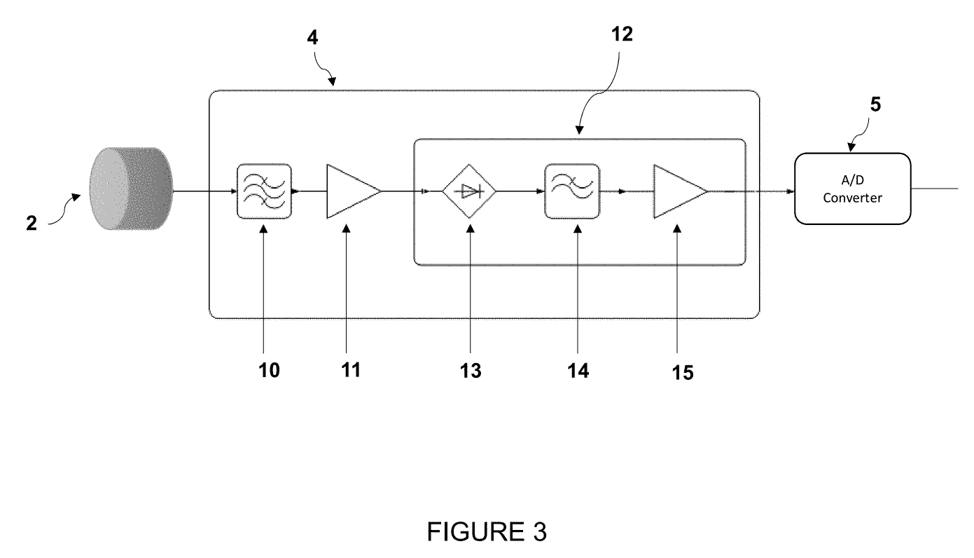

FIG. 3 shows the parts that preferably compose the ultrasonic signal receiver circuit 4. After the capture of the ultrasonic signal reflected by the bubbles by means of the electric receiver transducer 2, the same are processed by a band pass filter 10 to reduce the noise outside of the band of interest, whose band of pass has a central frequency equal to the frequency of the signal generated by the emitter circuit, f_{c}. Coupled to the band pass filter 10 there is a signal amplifier 11 that allows to amplify the amplitude of the signal that is transmitted to the envelope detector 12. This system allows to extract the envelope of the signal reflected by the bubbles. The envelope detector 12 is composed of a rectifier bridge 13 that rectifies the waveform in order to have a constant polarity. Coupled to said rectifier bridge there is a low-pass filter 14 that eliminates the signal of frequency f_{c} to preserve only the envelope of the signal for the following steps. The cut off frequency chosen in the low-pass filter 14 must be such as to allow to eliminate the signal of frequency f_{c} and, at the same time, to be used as an anti-alias filter to the following analogue-to-digital conversion step with the analogue-to-digital converter 5. After passing by the low pass filter, the signal is represented as the potential difference between its two ends. In order to deliver the signal to a digitalized signal processor 6, the signal is ground referenced and amplified using a differential amplifier 15. The analogue-to digital-converter 5 coupled to the amplifier 15 converts the signal to be capable of being processed and analyzed in the digitalized signal processor 6.

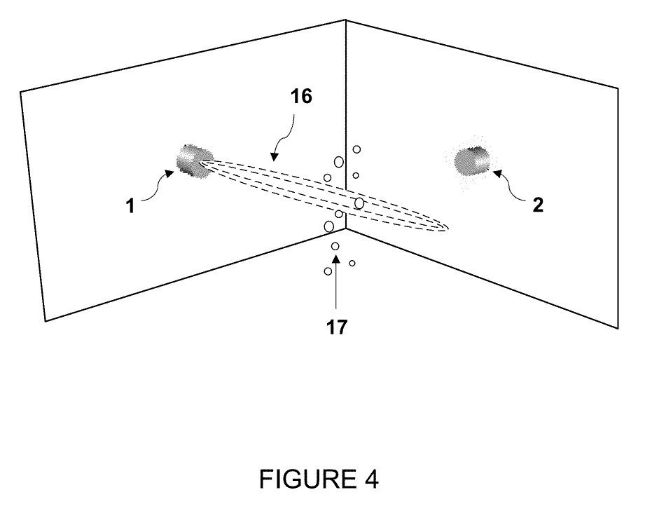

With the described device, it can be performed the methodology to determine and classify the sizes of bubbles that are present in a liquid medium. In FIG. 4 it is shown a schematic of the coherent or directional ultrasonic field that the bubbles cross. Through the ultrasonic signal emitter circuit 3 it is generated the time sustained ultrasonic signal—the term “sustained” meaning the opposite to a signal being generated by pulses or pulses trains—having a fundamental frequency f_{c} that is then emitted by the electric emitter transducer 1. The signal emitted into the liquid is sinusoidal and its wavelength in the liquid is lower than the smallest diameter of the bubbles to be classified. This signal is emitted by the emitter transducer 1, generating an ultrasonic field 16 corresponding to a coherent beam through which the bubbles 17 cross. The bubbles 17 that cross the beam reflect the signal that is captured by the electric receiver transducer 2, which also has a coherent directive gain. The electric signal captured by the electric receiver transducer 2 that corresponds to the ultrasonic waves reflected by the bubbles 17 is processed by the ultrasonic signal receiver circuit 4 where it passes through the envelope detector 12 that is designed to capture the distinctive characteristics of the different bubbles sizes inherent to the reflected ultrasound signals by means of the generation of 2-D time-domain patterns. These 2-D patterns have incorporated the information of the rising velocity of the bubbles, that, on its side, depends on the size of the same.

As a way of example, in a controlled environment, a rising air bubble experiments, mainly, a drag force (F_{D}) and a buoyancy (F_{B}) at opposing directions, that is, under equilibrium, F_{D}=−F_{B} The buoyancy force is expressed as F_{B}=pVg, and the drag force as F_{D}=0.5Cpv²πr² where p is the density of the liquid, g is the acceleration of gravity, V and r are the volume and the radius of the bubble, respectively, v is the rising velocity of the bubble and C is the drag coefficient. This indicates that the rising velocity of the bubble varies proportionally with its size. Therefore, the bigger bubbles rise to the surface with a higher velocity, their perturbations or instabilities in the trajectory are faster, and there are more high frequency components in the 2-D time-domain patterns generated by the receiver circuit. The result of the processing of the ultrasonic signal reflected by the bubble by means of the ultrasonic signal receiver circuit 4 is the obtainment of 2-D time-domain patterns containing information of the size of the bubbles.

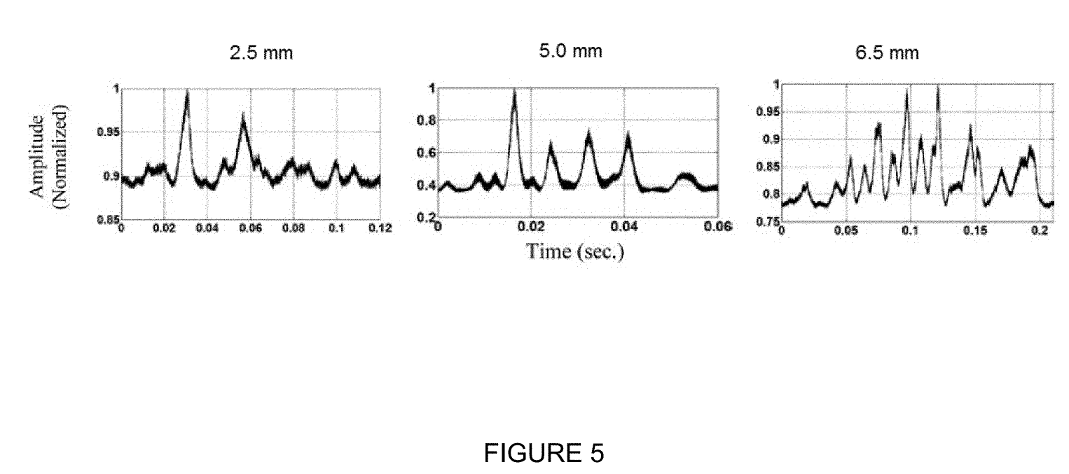

FIG. 5 shows three examples of two-dimensional patterns, represented with a normalized amplitude as a function of the time in seconds, of three different bubbles sizes, 2.5 mm, 5 mm and 6.5 mm, respectively. These plots are obtained after the signal captured by the receiver transducer 2 is processed with the band pass filter 10, amplified with the signal amplifier 11 and its envelope is extracted with the envelope detector 12 in the receiver circuit 4.

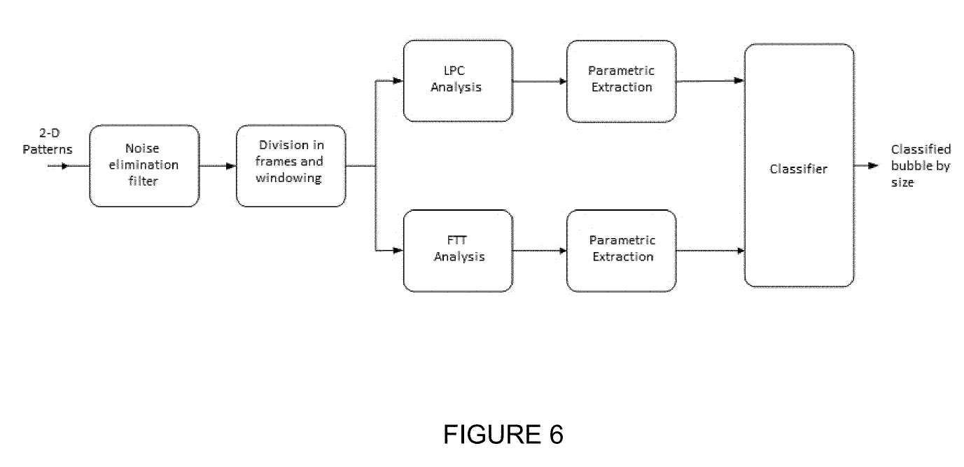

After the frequency-domain patterns are obtained, by means of the digitalized signal processor 6, the signals are processed for their subsequent classification. In FIG. 6 it is shown a schematic of the processing of the signals in the frequency domain. After the analogue-to-digital conversion of the signal, they are filtered to eliminate the noise, and are divided in frames of constant duration that are multiplied by an appropriate window, such as Hamming, Hanning, etc. In each window, simultaneously, both the fast Fourier transform (FFT) and the linear prediction coding (LPC) are estimated. The obtained patterns are denominated as “frequency domain patterns”. As a result of both the FFT and the LPC analysis, the parameters for the classification of the bubbles sizes are extracted, which is indicated in FIG. 6 as parametric extraction. These parameters may be spectral centroid, spectral entropy, spectral slope or any other similar that may be obtained from the FFT and the LPC coefficients. With these parameters the sizes of the bubbles can be estimated and classified by means of a process of classification with a trained classifier.

The classification process consists of two steps: training a classifier and testing or operation with the trained classifier. A classifier is understood as those mathematical models that are implemented with a program in the digitalized signal processor 6, such as neural networks or the Bayesian classifier. The training step consists of entering and estimating the coefficients of the classifier with the parameters extracted in the frequency domain for the classification of bubbles of known sizes. For this process, the coefficients of the predictor polynomial, in the case of the LPC analysis, and, also, the classification parameters extracted from the FFT of bubbles of known size are used. Then, during the testing or operation, the analysis is performed for bubbles of unknown size, for which the necessary parameters are extracted for their classification. The testing or operation step consists in using said parameters for the classification of bubbles of unknown sizes and entering them into the trained classifier, which allows to categorize or classify the bubbles in one of the previously trained sizes.

Due to the components, their configuration in the equipment and the methodology applied in this invention, the masking and interference when multiple bubbles that are measured is reduced in comparison to the methodologies for the measurement of bubbles based on resonance frequency. Additionally, the use of only one sinusoidal component sustained in time, that is, not using pulses or pulses trains, simplifies the electronic that is required in the emitter and receiver circuits. Finally, the present invention allows the determination on-line and without human supervision of the diameter of the bubbles, in contrast with other technologies, such as those based on photography.

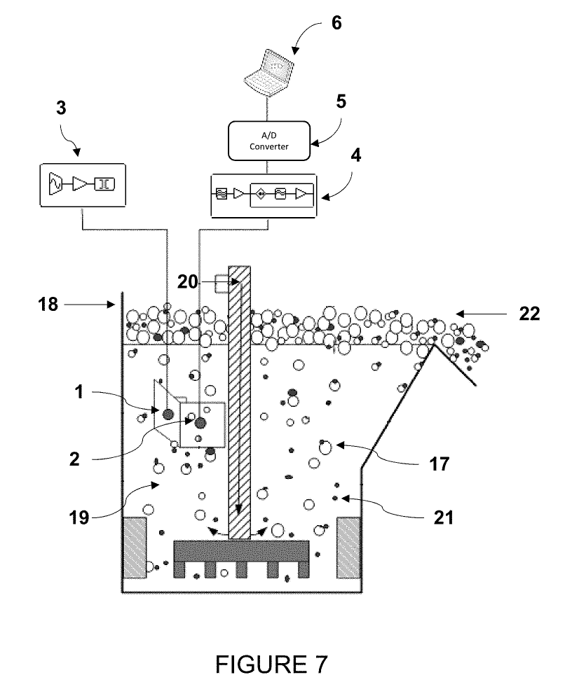

An embodiment of the invention is that one shown in FIG. 7, corresponding to a froth flotation cell 18, such as those used in mining, for the selection of particles of interest. The operation of selective separation of particles by flotation takes place from a suspension of said particles in a liquid medium, denominated pulp phase 19, which is introduced in the froth flotation cell 18. This industrial process consists in the injection of air 20 through a tube into the froth flotation cell 18, in which bubbles 17 are generated in the bottom of the cell, that start their rising at different velocities depending on the size of the same. When they rise to the surface, the bubbles 17 drag the particles in suspension 21, which accumulate at the surface forming a foam phase 22 that is subsequently removed in a permanent way from the rest of the suspension, constituting the concentrate of the process. The sizes of the bubbles in this process must be, depending on the case, of approximately 1 mm, nevertheless, the size varies according to the air injection 20. When the mode of the size of the bubbles is displaced to significantly lower or higher values, the process becomes inefficient. To diagnose the functioning of the flotation process, the device for the classification of the bubbles size is inserted in the cell, as shown in FIG. 7. The electric emitter 1 and receiver 2 transducers are placed inside the froth flotation cell 18, operatively coupled to the ultrasonic signal emitter circuit 3 and to the ultrasonic signal receiver circuit 4, respectively. The signal is generated by the signal emitter circuit 3 and emitted by the electric emitter transducer 1 forming an ultrasonic field. When the bubbles with and without particle rise, some of them cross this ultrasonic field and reflect ultrasonic signals that are captured by the electric receiver transducer 2. The captured signal is processed with analog electronic by the ultrasonic signal receiver circuit 4, generating 2-D time-domain patterns according to the sizes of the bubbles. The analogue-to-digital converter 5 digitalizes the signal for its analysis by means of the digitalized signal processor 6. The sizes of the bubbles are then classified by means of the processing of the necessary parameters for the classification in the trained classifier, which allows to track the process of generation of bubbles on-line and without human supervision, and so to adjust, as automatically as possible, the air injection to regulate the formation of bubbles at the required size for the process of flotation.

1. A device for the classification of bubble sizes in a liquid medium, comprising:
an electric ultrasonic signal emitter transducer;
an electric ultrasonic signal receiver transducer, located at an angle lower than 180 degrees with respect to the electric emitter transducer;
ultrasonic signal emitter and receiver circuits, operatively connected to said electric emitter and receiver transducers, respectively;
an analogue to digital converter connected to the ultrasonic signal receiver circuit; and
a digitalized signal processor connected to the analogue-to-digital converter.

2. The device of claim 1, wherein the electric ultrasonic signal receiver transducer is located at an angle of 90 degrees with respect to the electric emitter transducer.

3. The device of claim 1, wherein the emitter circuit comprises an ultrasonic signal generator coupled to a power amplifier and this one, on its side, to an impedance adapter.

4. The device of claim 3, wherein the ultrasonic signal generator generates a time sustained signal having a fundamental frequency f_{c} that is emitted by the electric emitter transducer into the liquid.

5. The device of claim 4, wherein the signal emitted into the liquid is sinusoidal and its wavelength in the liquid corresponding to the fundamental frequency f_{c} has to be lower than the smallest diameter of the bubbles to be classified.

6. The device of claim 1, wherein the ultrasonic signal receiver circuit comprises a band pass filter, next to which is positioned a signal amplifier and coupled to this one an envelope detector.

7. The device of claim 6, wherein the band pass filter presents a pass band having a central frequency that is the same frequency f that the signal generated by the emitter circuit.

8. The device of claim 6, wherein the envelope detector comprises a wave rectifier bridge, connected to a low pass filter and a signal amplifier connected to this last one.

9. A method for the classification of bubble sizes, comprising the steps of:
generating an ultrasonic field by means of an ultrasonic signal emitter circuit and emitting said ultrasonic field by means of an electric ultrasonic signal emitter transducer;
detecting bubbles crossing said ultrasonic field by means of an electric receiver transducer, said bubbles that reflect ultrasonic signals in correspondence to the rising velocity depending of their size;
processing with an ultrasonic signal receiver circuit the ultrasonic signal reflected by the bubbles to generate two-dimensional time-domain patterns containing information of the size of the same;
processing the two-dimensional time-domain patterns by means of digital processing techniques of signal in the frequency domain to generate frequency-domain patterns containing information of the size of the bubbles; and
classifying said frequency-domain patterns containing information of the size of the bubbles by means of a training step of a classifier and an operation step of the trained classifier.

10. The method of claim 9, wherein the ultrasonic signal generated by the ultrasonic signal emitter circuit is a time sustained signal having a fundamental frequency f_{c} that is emitted into the liquid by the electric emitter transducer.

11. The method of claim 10, wherein the signal emitted into the liquid is sinusoidal and its wavelength in the liquid corresponding to the fundamental frequency f_{c} has to be lower than the smallest of the diameters of the bubbles to be classified.

12. The method of claim 9, wherein for the processing of the ultrasonic signals reflected by the bubbles to generate the two-dimensional time-domain patterns containing information of the size of the same, the receiver circuit performs the additional steps of:
filtering the ultrasonic signals reflected by the bubbles in a band pass filter;
amplifying the filtered ultrasonic signals reflected by the bubbles using an amplifier; and
extracting the envelope of the signals reflected by the bubbles by means of an envelope detector.

13. The method of claim 12, wherein the step of extracting the envelope of the signals reflected by the bubbles to generate two-dimensional time-domain patterns containing information of the size of the same comprises the additional steps of:
rectifying the signal reflected by the bubbles by means of a rectifier bridge;
filtering the rectified ultrasonic signals reflected by the bubbles by means of a low pass filter to obtain the two-dimensional time-domain patterns; and
amplifying the two-dimensional time-domain patterns with an amplifier connected to an analogue to digital converter.

14. The method of claim 9, wherein the processing of the two-dimensional time-domain patterns by means of digital processing technique in the frequency domain to the generation of frequency-domain patterns containing information of the size of the bubbles comprises, additionally, the steps of:
dividing the ultrasonic signals in frames having a constant duration and multiplying them by an appropriate window;
estimating simultaneously in each frame the fast Fourier transform and the linear prediction coefficients; and
extracting from the fast Fourier transform and from the linear prediction coding the necessary parameters for the classification of the bubbles.

15. The method of claim 14, wherein the necessary parameters for the classification of the bubbles resulting from the processing in the frequency domain with the fast Fourier transform and from the linear prediction coding are selected from the group consisting of spectral centroid, spectral energy, spectral entropy, spectral slope, spectral crest factor, spectral roll off and linear prediction coefficient.

16. The method of claim 9, wherein the classifier is selected from the group including neural networks and bayesian classifier.

17. The method of claim 16, wherein the step of training the classifier comprises estimating the coefficients of the classifier from the necessary parameters for the classification of bubbles with bubbles of known sizes.

18. The method of claim 9, wherein the step of operating with the trained classifier comprises using the necessary parameters for the classification of bubbles of unknown sizes and classifying them according to their size with the trained classifier.
